(19) United States
(12) Patent Application Publication
(10) Pub. No.: US 2024/0368500 A1
(43) Pub. Date: Nov. 7, 2024

(54) MACHINE DISHWASH DETERGENT

(71) Applicant: Conopco Inc., d/b/a UNILEVER, Englewood Cliffs, NJ (US)

(72) Inventors: Alastair Richard Sanderson, Wageningen (NL); Craig Warren Jones, Wageningen (NL); Alison Cummins, Wageningen (NL)

(73) Assignee: Conopco Inc., d/b/a UNILEVER, Englewood Cliffs, NJ (US)

(21) Appl. No.: 18/553,847

(22) PCT Filed: Apr. 14, 2022
(86) PCT No.: PCT/EP2022/059984

§ 371 Date: Oct. 4, 2023

(30) Foreign Application Priority Data
Apr. 15, 2021 (EP) 21168537.5

(51) Int. Cl. C11D 1/72; C11D 3/20; C11D 3/33; C11D 17/04

(52) U.S. Cl. CPC C11D 1/72; C11D 3/2086; C11D 3/33; C11D 17/042

(57) ABSTRACT

A packaged machine dishwash detergent composition comprising a surfactant comprising a C8-22 alkyl chain and a mole average of from 2 to 100 ethoxylate units, wherein the surfactant is made by a manufacturing process including the step of using one or more surfactant-precursors obtained via gas-fermentation; and wherein the surfactant has a pMC level of at least 5%.

### TECHNICAL FIELD OF THE INVENTION

The present invention relates to machine dishwash detergent compositions comprising surfactant, wherein the surfactant is made by a manufacturing process including the step of using one or more surfactant-precursors obtained via gas-fermentation.

### BACKGROUND OF THE INVENTION

Machine dishwash detergent compositions typically contain several different active components, including builders, surfactants, enzymes and bleaching agents. Surfactants are employed to remove stains and soil and to disperse the released components into the cleaning liquid. Enzymes help to remove stubborn stains of proteins, starch and lipids by hydrolyzing these components. Bleach is used to remove stains by oxidizing the components that make up these stains. In order to reduce the negative effects of in particular calcium and magnesium ions on stain/soil removal so called ‘builders’ (complexing agents) are commonly applied in detergent compositions.

Fragrances are often the most impactful sensory component in a product, in particular when the machine dishwash detergent package is opened for the first time. The same applies to the color of a machine dishwash product and its general appearance.

Nowadays consumers desire machine dishwash products with reduced environmental impact, both in its production and after use. However, consumers tend to distrust on-pack claims about reduced environmental impact or distrust the basis of the on-pack claims. It is therefore desired to provide a machine dishwash product detergent which itself can provide credibility to environmental benefits claimed on the product pack/container. In addition, it is desired that such machine dishwash products have short ingredient listings, wherein each ingredient listed has a recognized (cleaning) function. This improves consumer understanding and trust of the product. Although consumers desire machine dishwash products with reduced environmental impact, an important caveat is that there should be little or no compromise on the cleaning efficiency of the product as well as product stability.

It is an object of the present invention to provide a machine dishwash detergent which has a reduced environmental impact, with little or no compromise of product efficiency and/or stability, wherein the detergent formulation itself provides an authentic link between reduced environmental impact and the sensory profile, preferably the odor or headspace profile, and more preferably wherein the formulation ingredient list need not be longer than conventional products.

### SUMMARY OF THE INVENTION

One or more objects of the invention have been achieved in a first aspect by a packaged machine dishwash detergent composition comprising a surfactant comprising a C8-22 alkyl chain and a mole average of from 2 to 100 ethoxylate units, wherein the surfactant is made by a manufacturing process including the step of using one or more surfactant-precursors obtained via gas-fermentation; and wherein the surfactant has a pMC level of at least 5%.

We have surprisingly found that such a machine dishwash composition, when packaged can provide a headspace gas composition which is different from products made with such surfactants derived from fully petrochemical sources. In particular, the odour provided by the surfactants of the invention is detectable by nose alone by the average consumer and different products containing petrochemically derived surfactants. The altered headspace afforded by the surfactants of the invention is believed to be a direct consequence of the different manner in which the surfactants of the invention are manufactured. These odors provide a beneficial differentiating heads-space and smell to machine dishwash compositions comprising such. The invention relies in part on the unexpected finding that providing a surfactant as claimed which is made in a process involving gas-fermentation provides such difference detectable by the human nose.

Moreover, we surprisingly found that surfactants derived (even in part) from petrochemical sources resulted in a ‘chemical’ odour, while those derived from a process involving gas-fermentation provided a ‘fatty/waxy” odour. This finding is highly beneficial as it allows the consumer upon opening the pack to verify the on-pack claimed reduced environmental impact of the detergent in an authentic way, one which can be directly linked to the way the surfactant was produced. Moreover, the reduced ‘chemical’ odour impression fits exactly with the fact that the surfactants used in the invention are produced in a more sustainable manner. This is wholly unexpected. In addition, the distinctive odour provided by surfactants of the invention is authentic since it derives from the used surfactants which are a known major active in machine dishwash detergents.

Importantly the altered headspace profile is considered difficult to adulterate/forge with intentionally added perfumes in combination with fully petrochemical surfactants. Such products may be even more difficult to adulterate/forge with surfactants having at least 5% of the carbon of the surfactant being modern carbon (i.e. derived from the atmosphere or bio-sources) as this can factually be measured using the level of pMC (percent modern carbon) of the surfactant.

The current invention thus allows a more environmentally friendly machine dishwash composition which is considered difficult to adulterate/forge and which provides authentic (verifiable) cues to the consumer. Moreover, use of the invention does not require lengthening the ingredient list and does not compromise on performance. All of these are very helpful in building/maintaining consumer trust and, hence in reducing environmental impact when used in place of such detergents with (fully) petrochemical-based surfactants. In general, that the machine dishwash composition of the invention is packaged is further helps to build-up headspace-odour strength upon first opening by the consumer so it can be more easily and immediately detect the surfactant-associated odour. What was further surprisingly found is that use of a surfactant according to the invention in fact produces a higher concentration of headspace volatiles. This makes the surfactant-origin even better discernible by the average consumer.

The invention further relates to a process for the manufacture of a packaged machine dishwash detergent composition which can provide the authentic heads-space odour upon first opening.

The invention further relates to the use of a surfactant as used in the invention to provide an odour in a packaged detergent composition which is distinct from (partly or fully) petrochemical based surfactants, as determined by the average human nose upon opening, without relying on added perfume (although these are not excluded per se).

The invention further relates to the use of a surfactant according to the invention to provide a packaged machine dishwash detergent composition which has on-pack information about having reduced environmental impact which is more difficult to adulterate and/or forge with fully petrochemical derived surfactants.

The invention further relates to the use of a surfactant according to the invention to provide a scent marker in a machine dishwash detergent composition to indicate the use of bio-fermentation in the manufacture the surfactant, which includes the manufacture of any used surfactant precursors.

### DETAILED DESCRIPTION OF THE INVENTION

### Definitions

Weight percentage (wt. %) is based on the total weight of the detergent composition unless otherwise indicated or as made clear from the context. It will be appreciated that the total weight amount of ingredients will not exceed 100 wt. %. Whenever an amount or concentration of a component is quantified herein, unless indicated otherwise, the quantified amount or quantified concentration relates to said component per se, even though it may be common practice to add such a component in the form of a solution or of a blend with one or more other ingredients. It is furthermore to be understood that the verb “to comprise” and its conjugations is used in its non-limiting sense to mean that items following the word are included, but items not specifically mentioned are not excluded. Finally, reference to an element by the indefinite article “a” or “an” does not exclude the possibility that more than one of the elements is present, unless the context clearly requires that there be one and only one of the elements. The indefinite article “a” or “an” thus usually means “at least one”. Unless otherwise specified all measurements are taken at standard conditions. Whenever a parameter, such as a concentration or a ratio, is said to be less than a certain upper limit it should be understood that in the absence of a specified lower limit the lower limit for said parameter is 0. Concentrations expressed in wt. % of ‘free acid equivalent’ refer to the concentration of the compound expressed as wt. %, assuming it would be in fully protonated from. The following table shows how the free acid equivalent concentrations can be calculated for some (anhydrous) aminopolycarboxylates and (anhydrous) acid salts.

| | Wt. % | Conversion | Wt. % free acid |
|---|---|---|---|
| | salt | factor | equivalent |
| GLDA (tetrasodium salt) | 50 | 263.1/351.1 | 37.5 |
| MGDA (trisodium salt) | 50 | 205.1/271.1 | 37.8 |
| Citric acid (monosodium | 50 | 192.1/214.1 | 44.9 |
| salt) | | | |
| Sodium acetate | 50 | 60.0/82.0 | 36.6 |

COx is defined as CO₂, CO or a mixture thereof.

### Carbon Capture

Carbon capture refers to the capture or sequestration of C1 carbon molecules (e.g. carbon monoxide, carbon dioxide, methane or methanol), preferably carbon dioxide and carbon monoxide. The carbon to be captured may be in any physical state, such as a liquid or gas, preferably as a gas. (Gaseous) carbon is preferably captured from waste emissions, such as exhaust gases from industrial processes, known as “point sources”) or directly from the atmosphere. Such point sources are preferably chosen from industrial bioprocess point sources, such as those from breweries, or any other industry in which at least part, preferably at least 50% and even more preferably substantially all the emitted C1 waste (gas) is derived from renewable biomaterial. For example, breweries convert plant-based sugars as renewable biomaterial and emit CO₂ as waste by-product into the atmosphere. Other examples of biomass-based point sources of C1 carbon molecules, also in view of methane, are waste emissions from dairy farms and municipal waste-water treatment plants. C1 carbon material derived from renewable biomass can be readily distinguished from fossil fuel derived C1 carbon material using radiocarbon (C14) measurement. Hence it is preferred that the C1 carbon captured has a pMC level of at least 5%, 10%, 20%, 30%, 40%, 50%, 60%, 70%, 80%, 90% and still more preferable at least 95%. Even more preferably it has a pMC level substantially equal to the gaseous carbon in the atmosphere.

Carbon may be captured from the C1 waste products arising from usage of fossil fuels, but then preferably only in part. For example, carbon may be captured from the exhaust gases of fossil fuel burning power generation plants or fossil fuel operating steel mills. However, if for example a point source is based on an electric power generation plant, preferred are those using biomass as fuel rather than fossil fuel.

In general, for capturing C1 carbon, point sources are the more effective due to the higher concentration of C1 carbon compared to the prevailing concentration in the atmosphere. Hence point sources are preferred from a technology perspective. However, direct C1 carbon capture from the atmosphere has its own distinct benefits. To name but one is the greater flexibility of where the C1 capturing facility can be located.

Thus, preferably the C1 carbon is captured at a point source. Preferably from a point source which provides C1 carbon containing radiocarbon (C14). Preferably the C1 carbon is captured as a gas.

Where required, preferably, the method used to capture the carbon includes one or more of biological separation, chemical separation, absorption, adsorption, gas separation membranes, diffusion, rectification or condensation or any combination thereof.

Processes that collect C1 carbon sources from the air may use solvents that either physically or chemically bind C1 carbon from the air. Solvents include strongly alkaline hydroxide solutions like, for example, sodium and potassium hydroxide. Hydroxide solutions in excess of 0.1 molarity can readily remove CO₂ from air. Higher hydroxide concentrations are desirable, and an efficient air contactor will use hydroxide solutions in excess of 1 molar. Sodium hydroxide is a particular convenient choice, but other solvents may also be of interest. Specifically, similar processes may be useful for organic amines as well. Examples of carbon capture include amine scrubbing in which for example COx-containing exhaust gas passes through liquid amines to absorb most of the COx. The carbon-rich gas is then pumped away. Preferably, the processes that collects gaseous C1, from the air may use solvents selected from, sodium and potassium hydroxide or organic amines.

The captured C1 carbon may be captured as a solid or liquid for example as a bicarbonate, carbonate or hydroxide from which the C1 carbon may be extracted using well know chemistries or it may be utilized as such as a gas. Electrochemical methods for carbon dioxide recovery from alkaline solvents for carbon dioxide capture from air may be used as in US 2011/108421.

### Gas Fermentation

In view of the current invention, at least part of the C1 carbon captured and preferably all of the C1 captured, as used to make the final surfactant of the invention is converted via gas-fermentation. Gas fermentation can offer the benefit of not using heterologous feedstocks such as sugars that affect food supply chain and can be used for the conversion of (waste) gas to valuable liquid chemicals. Gas fermentation usually refers to the liquid fermentation of gaseous sources. Gas fermentation can convert C1 carbon by the use of microbes into to useful (intermediate) products which can as needed be further processed to make (pre-cursors for) surfactants as explained below.

Gas-fermentation enables the biological conversion of C1 carbon in a range of useful compounds. Examples include ethanol, acetic acid, butanol, butyric acid, methane. For example, COx captured can be converted into methane, which can be further converted to more useful compounds downstream. Aerobic methane fermentation can convert methane also directly into e.g. methanol, formaldehyde and organic acids. Such C1 gas-fermentation products are considered (C1) gas-fermentation products (i.e. the product of C1 gas fermentation) even though these may have more than 2 carbon atoms. Preferably the C1 gas fermentation products have from 2 to 6, preferably from 2 to 3 and even more preferably 2 carbon atoms.

As indicated, CO— and CO₂-rich waste gases are an attractive substrate for gas fermentation. Many industrial processes produce large amounts of carbon-rich gas that is often expelled into the atmosphere unused, thereby contributing to elevated concentrations of in particular CO₂. The availability of substrate for gas fermentation can be broadened when considering biomass feedstock converted into carbon- and energy-rich gas streams via gasification. Gasification is the conversion of (e.g. solid, liquid) carbon-rich feedstock to gaseous products, including C1 carbon, which can involve partial or complete oxidation. The gasification can be by thermo-chemical conversion and biological conversion. Gasification can for example be achieved using the four steps of drying, pyrolysis, oxidation, and reduction. Gasification of biomass typically results in a mixture comprising CO, CO₂, H₂ and CH₄. Gasification could also be applied to alternative carbon rich substrates including plastic and even fossil fuels like coal. As mentioned earlier however, preferred C1 carbon sources are based on renewable biomass.

Nutrients required for microbe growth and/or optimal gas-fermentation activity may be added as needed to the gas-captured stream and/or directly to the fermentation liquid. Sulfur for example can be added in the form of one or more sulfur-containing species (SCSs) such as H₂S, SO₂, and/or other sulfur oxides (SOx) as part of the gas. Sulfur compounds may also be supplied directly in the fermentation liquid. The sulfur species concentration can be in the range of 1 ppm-10 ppm, 5 ppm-50 ppm, 5 ppm-100 ppm, 10 ppm to 200 ppm, 20 ppm to 1000 ppm, and/or any other suitable range. Other nutrients can be added depending on the specific requirements of the gas-fermenting microorganisms.

Exemplary gas fermentation processes are, but not limited to, anaerobic fermentation, such as syngas fermentation, and aerobic methane fermentation as described (B. Geinitz et. al. Gas Fermentation Expands the Scope of a Process Network for Material Conversion. Chemie Ingenieur Technik. Vol 92, Issue 11, p. 1665-1679.). The microbes with the ability to convert CO and CO₂ fall primarily into the group of anaerobic acetogenic bacteria or aerobic carboxydotrophic bacteria, those able to convert methane are generally called methanotrophs, which are usually aerobic methanothrophic bacteria. In this sense the term ‘gas fermentation’ is used loosely and includes the aerobic or anaerobic microbial or enzymatic conversion of C1 carbon and preferably refers to anaerobic gas fermentation of COx carbon by microbes and/or the aerobic methane fermentation by microbes and more preferably refers to the anaerobic gas fermentation of COx carbon by microbes.

Examples of suitable microbes include Clostridium autoethanogenum, Clostridium carboxidovorans, Clostridium ljungdahlii (strain PETC or ERI2, among others [See e.g., U.S. Pat. Nos. 5,173,429; 5,593,886 and 5,821,111; and references cited therein; see also WO98/00558. WO 00/68407 discloses strains of Clostridium ljungdahlii for the production of ethanol), Clostridium ragsdalei, Clostridium thermoaceticum, Clostridium thermoautotrophicum, Eubacterium limosum, Peptostreptococcus productus, Butyribacterium methylotrophicum, acetogens, and/or E. cob.

The ability of micro-organisms to grow on CO as a sole carbon source was first discovered in 1903. This was later determined to be a property of organisms that use the acetyl coenzyme A (acetyl CoA) biochemical pathway of autotrophic growth (also known as the Woods-Ljungdahl pathway and the carbon monoxide dehydrogenase/acetyl COA synthase (CODH/ACS) pathway). A large number of anaerobic organisms including carboxydotrophic, photosynthetic, methanogenic and acetogenic organisms have been shown to metabolize CO to various end products, namely CO₂, H₂, methane, n-butanol, acetate and ethanol. Preferably anaerobic bacteria such as those from the genus Clostridium are used to produce ethanol from carbon monoxide, carbon dioxide and hydrogen via the acetyl CoA biochemical pathway. There are a variety of microorganisms that can be used in a fermentation process, particularly preferred are anaerobic bacteria such as Clostridium ljungdahlii strain PETC or ERI2, which can be used to produce ethanol.

Gas-fermentation can include multi-stage fermentation, mixed fermentation, co-cultivation, mixotrophy and thermophilic production. Multi-stage fermentation can broaden the portfolio of products obtained together with higher end-product concentrations. Mixed fermentation may help some strains to detoxify the environment from a toxic compound or reduce the concentration of a certain product allowing for a more efficient conversion of the gas or increased product yield (e.g. by a second strain). Mixotrophy is the use of two or more carbon/electron sources simultaneously by some microorganisms, where for example both CO₂ and organic substrates such as sugars are utilized together. Thermophilic production (gas-fermentation at elevated temperatures by thermophilic strains, such as carboxydotrophic thermophiles) offers the advantages of reducing the risk of contamination. The gas-fermentation cultures may be defined or undefined, but preferably are in part or in the whole defined. Use of defined cultures offers the benefit of improved gas-fermentation end-product control. Gas-fermentation is as mentioned useful to convert C1 carbon sources into value-added intermediate products, from which more complex chemicals may be produced. These include preferably excreted products C2-C8 products such as carbohydrates, acids, alcohols, alkanes, alkenes, but can include more complex, which are often not excreted such as biopolymers, proteins and other cellular constituents. Such products typically can be obtained from the cellular biomass of the gas fermenting organisms. Preferred gas-fermentation end-products include ethanol, ethylene, acetate, caproate, decan, ethanol, butanol, lactate, butyrate and ethyl acetate and more preferably include ethanol and ethylene.

Various other (gaseous) C1 conversion processes can optionally be used alongside the gas-fermentation route. Such methods include chemical transformation by Fischer-Tropsch using a hydrogen catalyst; conversion to ethanol chemically using a catalyst of copper nanoparticles embedded in carbon spikes or solar photo-thermochemical alkane reverse combustion.
1. CO₂ or CO can be chemically transformed to liquid hydrocarbons by Fischer-Tropsch (FT) reactions with H₂ using metal catalysts. CO can be captured as CO or converted into carbon monoxide by a reverse water gas shift reaction. FT reactions are gas-based so solid C1 carbon sources may require gasification (the product of which is often terms “syngas”. The name comes from its use as intermediates in creating synthetic natural gas (SNG)).
2. CO₂ can be converted to ethanol chemically using a catalyst of copper nanoparticles embedded in carbon spikes.
3. Solar photo-thermochemical alkane reverse combustion reaction is a one-step conversion of CO₂ and water into oxygen and hydrocarbons using a photo-thermochemical flow reactor.

The process may further include a catalytic hydrogenation module. In embodiments utilizing a catalytic hydrogenation module, the acid gas depleted stream is passed to the catalytic hydrogenation module, prior to being passed to the deoxygenation module, wherein at least one constituent from the acid gas depleted stream is removed and/or converted prior to being passed to the deoxygenation module. At least one constituent removed and/or converted by the catalytic hydrogenation module is acetylene (C2H₂). The process may include at least one additional module selected from the group comprising: particulate removal module, chloride removal module, tar removal module, hydrogen cyanide removal module, additional acid gas removal module, temperature module, and pressure module. Further examples of carbon capture technologies suitable to generate the ethanol stock for use in manufacturing ethoxy sub-units for use in the surfactants described herein are disclosed in WO 2007/117157, WO 2018/175481, WO 2019/157519 and WO 2018/231948.

### Manufacture of Alkyl

The C8-22 alkyl chain of the surfactant whether an alcohol ethoxylate or an alkyl ether sulphate is preferably obtained from a renewable source and preferably from a bio-based triglyceride. A renewable source is one where the material is produced by natural ecological cycle of a living species, preferably by a plant, algae, fungi, yeast or bacteria, more preferably plants, algae or yeasts. Preferred plant sources of oils are rapeseed, sunflower, maze, soy, cottonseed, olive oil and trees. The oil from trees is called tall oil. Most preferably Palm and Rapeseed oils are the source.

Algal oils are discussed in Energies 2019, 12, 1920 Algal Biofuels: Current Status and Key Challenges by Saad M. G. et al. A process for the production of triglycerides from biomass using yeasts is described in Energy Environ. Sci., 2019, 12, 2717 A sustainable, high-performance process for the economic production of waste-free microbial oils that can replace plant-based equivalents by Masri M. A. et al. Non-edible plant oils may be used and are preferably selected from the fruit and seeds of Jatropha curcas, Calophyllum inophyllum, Sterculia foetida, Madhuca indica (mahua), Pongamia glabra (koroch seed), Linseed, Pongamia pinnata (karanja), Hevea brasiliensis (Rubber seed), Azadirachta indica (neem), Camelina sativa, Lesquerella fendleri, Nicotiana tabacum (tobacco), Deccan hemp, Ricinus communis L. (castor), Simmondsia chinensis (Jojoba), Eruca sativa. L., Cerbera odollam (Sea mango), Coriander (Coriandrum sativum L.), Croton megalocarpus, Pilu, Crambe, syringa, Scheleichera triguga (kusum), Stillingia, Shorea robusta (sal), Terminalia belerica roxb, Cuphea, Camellia, Champaca, Simarouba glauca, Garcinia indica, Rice bran, Hingan (balanites), Desert date, Cardoon, Asclepias syriaca (Milkweed), Guizotia abyssinica, Radish Ethiopian mustard, Syagrus, Tung, Idesia polycarpa var. vestita, Alagae, Argemone mexicana L. (Mexican prickly poppy, Putranjiva roxburghii (Lucky bean tree), Sapindus mukorossi (Soapnut), M. azedarach (syringe), Thevettia peruviana (yellow oleander), Copaiba, Milk bush, Laurel, Cumaru, Andiroba, Piqui, B. napus, Zanthoxylum bungeanum.

### Manufacture of Surfactant.

The C1 carbon (fermentation) products, such as ethanol, are used to generate ethoxy subunits and, together with appropriate alkyl chains, is formed into the desired surfactant. Where sulfonation is required, for example to form an anionic surfactant such as alkyl ether sulphate, again, this is according to standard processes. In a first step the for example ethanol (C2H₅OH) is dehydrated to ethylene (C2H₄) and this is a common industrial process. Then the ethylene is oxidized to form ethylene oxide (C2H₄O). Finally, the ethylene oxide is then reacted with a long chain alcohol (e.g. C12/14 type fatty alcohol) via a polymerisation type reaction. This process is commonly referred to as ethoxylation and gives rise to surfactants that are known as alcohol ethoxylates and which are non-ionic surfactants. By sulphonating these alcohol ethoxylates one forms the alkyl ether sulphate anionic surfactants.

### Manufacture of EO

The ethoxylate units of the surfactant of the invention comprises (on average) at least one ethoxylate containing a carbon atom obtained from a C1 carbon captured. More preferably, at least 5%, 10%, 20%, 30%, 40% 50% of the ethoxylate groups and especially preferably at least 70% comprise carbon atoms obtained from carbon capture and most preferably all the ethoxylate groups present in the surfactant contain carbon obtained from carbon capture, which is converted by gas-fermentation into an intermediary product.

Preferably, the ethoxylate units in the surfactant comprises at least one ethoxylate containing two carbon atoms obtained from carbon capture. More preferably, at least 10%, 20%, 30%, 40%, 50%, 60& of the ethoxylate groups and especially preferably at least 70% comprise two carbon atoms obtained from carbon capture and most preferably all the ethoxylate groups present in the (non-ionic) surfactant contain two carbon atoms obtained from carbon capture. Preferably, less than 90%, preferably less than 10% of the ethoxylate groups comprise carbon atoms obtained from fossil fuel-based sources. Preferably, more than 10%, preferably more than 90% of the ethoxylate groups comprise carbon atoms obtained from carbon-capture based sources.

The machine dishwash product of the invention preferably comprises from 0.1 to 20 wt. % of a surfactant comprising a C8-22 alkyl chain and a mole average of from 2 to 100 ethoxylate units, wherein the surfactant is made by a manufacturing process including the step of using one or more surfactant-precursors obtained via gas-fermentation; and wherein the surfactant has at least 5% modern carbon, based on total carbon of the surfactant. More preferably said amount of surfactant is from 1 to 18 wt. %, even more preferably from 4 to 16 wt. % and still even more preferably from 6 to 12 wt. %.

Preferably at least 10% of the ethoxylate units of the surfactant of the invention is obtained from carbon capture, and in increasing order of preference at least 20%, 30%, 40%, 50%, 60%, 70%, 80%, 90% and at least 95%.

Preferably at least 10% of the carbon in the C8-C22 alkyl chain of the surfactant of the invention is obtained from carbon capture, from bio-based sourced or a combination thereof, and in increasing order of preference this amount is at least 20%, 30%, 40%, 50%, 60%, 70%, 80%, 90% and at least 95%.

Preferably at least 10% of the total carbons of the surfactant of the invention is carbon obtained from carbon capture, and in increasing order of preference at least 20%, 30%, 40%, 50%, 60%, 70%, 80%, 90% and at least 95%.

### Alcohol Ethoxylates

The surfactant preferably comprises a non-ionic surfactant. Preferably the detergent composition comprises from 0.1 to 20% wt. non-ionic surfactant based on the total weight of composition. Such non-ionic surfactants include, for example, polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 100 moles of ethylene oxide per mole of alcohol.

A preferred class of non-ionic surfactant for use in the invention includes aliphatic C₁₂ to C₁₅ primary linear alcohol ethoxylates with an average of from 3 to 20, more preferably from 5 to 10 moles of ethylene oxide per mole of alcohol. The alcohol ethoxylate may be provided in a single raw material component or by way of a mixture of components.

Preferably low-foaming non-ionic surfactants are used. The preferred ethoxylated alcohols include for example C₁₂₋₁₄ alcohols with 3 EO to 4 EO, C₉₋₁₂ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₉ alcohol with 5 EO.

Non-ionic surfactants from the group mixed alkoxylated alcohols and in particular from the group of EO-AO-EO non-ionic surfactants, are particularly preferentially used. Preferably used non-ionic surfactants originate from the groups comprising alkoxylated non-ionic surfactants, in particular ethoxylated primary alcohols and mixtures of these surfactants with structurally complex surfactants such as polyoxypropylene/polyoxyethylene/polyoxypropylene (PO/EO/PO). Such (PO/EO/PO) non-ionic surfactants are furthermore distinguished by good foam control.

The most preferred non-ionic surfactants are according to the formula:

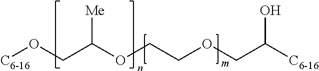

wherein n is from 0 to 5 and m from 10 to 40, more preferably wherein n is from 0 to 3 and m is from 15 to 40, and even more preferably wherein n is 0 and m is from 18 to 25. Surfactants according to this formula were particularly useful in reducing spotting of dishware treated in a machine dish washer.

The detergent composition of the invention comprises from 0.1 to 20 wt. % of a non-ionic surfactant or a mixture of two or more non-ionic surfactants. The preferred amount of total non-ionic surfactant if from 1 to 18 wt. %, more preferably from 4 to 16 wt. % and even more preferably from 6 to 12 wt. %. Such levels are considered optimal for providing improved detergency and further reduced spotting.

The non-ionic surfactant is preferably present in amounts of 25 to 100 wt. % based on the total weight of the surfactant system. Preferably the non-ionic surfactant is a mixture of two or more non-ionic surfactants, at least one of which is a non-ionic surfactant according to the invention, preferably all are non-ionic surfactants according to the invention.

The level of anionic surfactants in the machine dishwash composition of the invention preferably is from 0.1 to 4 wt. %, more preferably from 0.5 to 3 wt. %

### Anionic-Surfactants

Anionic Surfactant are described in Anionic Surfactants Organic Chemistry (Surfactant Science Series Volume 56) edited By H. W. Stache (Marcel Dekker 1996). Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed. Sodium and potassium are preferred.

The compositions according to the invention may include alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ. Some alkyl sulfate surfactant (PAS) may be used, such as non-ethoxylated primary and secondary alkyl sulphates with an alkyl chain length of from 10 to 18. Mixtures of any of the above described materials may also be used.

The surfactant of the invention is made by a process which includes the step of using one or more surfactant-precursors obtains via gas-fermentation, which is a microbial process. As explained above, this results in converting the gaseous C₁ gas into a C₁ reduction product (such as alcohols, alkenes, alkanes and acids) and preferably provides C₂ reduction products, more preferably ethanol or ethylene oxide. These then can be used to provide the EO-moieties to provide the 2-100 ethoxylate units and/or the moieties to produce the alkyl chain, or both. When using ethanol preferably these are first be converted to ethylene oxide to facilitate the transformation. These processing steps are considered distinct from the way petrochemically-derived surfactants are made and provide a distinct odor and headspace when using surfactant of the invention.

Preferably the surfactant as used in the invention comprises from 0.00001 to 2 wt. %, more preferably from 0.0001 to 1.5 wt. %, even more preferably from 0.001 to 1.0 wt. % of volatile compounds which includes one or more of n-butanol, acetic acid, aldehydes, amines, ethyl acetate, ethyl, ketones.

### Percent Modern Carbon

Where the carbon obtained from carbon capture is derived from atmospheric air-based carbon or from bio-based gas emissions (e.g. industrial point emissions), the surfactant can be improved in terms of raising the level of percent modern carbon (or pMC) of the surfactant, and consequently of the composition as a whole. This provides a further way to tune the headspace profile to be distinct from a petrochemical-surfactant derived one. Furthermore, it makes adulteration more difficult. Measuring the pMC value is based on measuring the level of radiocarbon (C14) which is generated in the upper atmosphere from where it diffuses, providing a general background radiocarbon level in the air. The level of C14, once captured (e.g. by biomass) decreases over time, in such a way that the amount of C14 is essentially depleted after 45,000 years. Hence the C14 level of fossil-based carbons, as used in the conventional petrochemical industry is virtually zero.

A pMC value of 100% biobased or biogenic carbon would indicate that 100% of the carbon came from plants or animal by-products (biomass) living in the natural environment (or as captured from the air) and a value of 0% would mean that all of the carbon was derived from petrochemicals, coal and other fossil sources. A value between 0-100% would indicate a mixture. The higher the value, the greater the proportion of naturally sourced components in the material, even though this may include carbon captured from the air.

The pMC level can be determined using the % Biobased Carbon Content ASTM D6866-20 Method B, using a National Institute of Standards and Technology (NIST) modern reference standard (SRM 4990C). Such measurements are known in the art are performed commercially, such as by Beta Analytic Inc. (USA). The technique to measure the C14 carbon level is known since decades and most known from carbon-dating archeological organic findings. The particular method used by Beta Analytic Inc., which is the preferred method to determine pMC includes the following:

Radiocarbon dating is performed by Accelerator Mass Spectrometry (AMS). The AMS measurement is done on graphite produced by hydrogen reduction of the CO₂ sample over a cobalt catalyst. The CO₂ is obtained from the combustion of the sample at 800° C.+ under a 100% oxygen atmosphere. The CO₂ is first dried with methanol/dry ice then collected in liquid nitrogen for the subsequent graphitization reaction. The identical reaction is performed on reference standards, internal QA samples, and backgrounds to ensure systematic chemistry. The pMC result is obtained by measuring sample C14/C13 relative to the C14/C13 in Oxalic Acid II (NIST-4990C) in one of Beta

Analytic's multiple in-house particle accelerators using SNICS ion source. Quality assurance samples are measured along with the unknowns and reported separately in a “QA report”. The radiocarbon dating lab requires results for the QA samples to fall within expectations of the known values prior to accepting and reporting the results for any given sample. The AMS result is corrected for total fractionation using machine graphite d13C. The d13C reported for the sample is obtained by different ways depending upon the sample material. Solid organics are sub-sampled and converted to CO₂ with an elemental analyzer (EA). Water and carbonates are acidified in a gas bench to produce CO₂. Both the EA and the gas bench are connected directly to an isotope-ratio mass spectrometer (IRMS). The IRMS performs the separation and measurement of the CO₂ masses and calculation of the sample d13C.

The packaged machine dishwash detergent composition according to the invention has a pMC level (as a whole), in order of increasing preference, of at least 10%, 20%, 30%, 40%, 50%, 60%, 70%, 80%, 90% and still even more preferably of at least 95%.

The packaged machine dishwash detergent composition according to the invention has a pMC level of the surfactant, as based on the total amount of surfactant, in order of increasing preference, of at least 10%, 20%, 30%, 40%, 50%, 60%, 70%, 80%, 90% and still even more preferably of at least 95%.

The packaged machine dishwash detergent composition according to the invention has a pMC level of the surfactant of the invention, as based on the total amount of the surfactant of the invention, in order of increasing preference, of at least 10%, 20%, 30%, 40%, 50%, 60%, 70%, 80%, 90% and still even more preferably of at least 95%.

The surfactant of the invention is made by a manufacturing process including the step of using one or more surfactant-precursors obtained via gas-fermentation and comprises 2 to 100 ethoxylate units. Preferably at least part of the 2 to 100 ethoxylate units are derived from pre-cursors which are obtain via gas-fermentation. More preferably at least 10%, 20%, 30%, 40%, 50% 60%, 70%, 80%, 90% and still even more preferably all of the ethoxylate units are derived from pre-cursors which are obtained via gas-fermentation.

### Aminopolycarboxylate

Aminopolycarboxylates are well known in the detergent industry and sometimes referred to as aminopolycarboxylic acids chelants. They are generally appreciated as being strong builders. Suitable aminopolycarboxylic acids include glutamic acid N,N-diacetic acid (GLDA), methylglycinediacetic acid (MGDA), ethylenediaminedisuccinic acid (EDDS), iminodisuccinic acid (IDS), iminodimalic acid (IDM), ethylenediaminetetraacetic acid (EDTA), nitrilotriacetic acid (NTA), iminodiacetic acid (IDA), diethylenetriaminepentaacetic acid (DTPA), hydroxyethyliminodiacetic acid (HEIDA) aspartic acid diethoxysuccinic acid (AES) aspartic acid-N,N-diacetic acid (ASDA), hydroxyethylene-diaminetetraacetic acid (HEDTA), hydroxyethylethylene-diaminetriacetic acid (HEEDTA), iminodifumaric (IDF), iminoditartaric acid (IDT), iminodimaleic acid (IDMAL), ethylenediaminedifumaric acid (EDDF), ethylenediaminedimalic acid (EDDM), ethylenediamineditartaric acid (EDDT), ethylenediaminedimaleic acid and (EDDMAL), dipicolinic acid.

Preferred aminopolycarboxylates are GLDA, MGDA, EDDS, IDS, IDM or a mixture thereof, more preferred are GLDA, MGDA, EDDS or a mixture thereof and even more preferred are GLDA and MGDA or a mixture thereof. Of these GLDA is especially preferred as it can be made from bio-based materials (e.g. monosodium glutamate, which itself can be made as by-product from corn fermentation). Also, GLDA itself is highly biodegradable. MGDA is more preferred in view of it being somewhat less hygroscopic, which improves detergent stability during storage.

The detergent composition according to the invention comprises from 0.5 to 40 wt. % free acid equivalent of aminopolycarboxylate. A particularly preferred amount of free acid equivalent of aminopolycarboxylate is from 0.5 to 20 wt. %, more preferably from 1.0 to 15 wt. %, even more preferably from 2.0 to 10 wt. % and still even more preferably from 3.0 to 8 wt. %.

Preferred salts are alkali-based salts and more preferred are sodium-based salts.

### pH Profile

The detergent composition of the invention preferably provides a pH of a solution of 1 wt. % of the detergent composition in water as measured at 25 degrees Celsius of from 7.0 to 12.0, more preferably of from 8.0 to 11.0 and even more preferably of from 8.5 to 10.5.

### Organic Acid

Inclusion of further organic acids and/or their corresponding salts (not being aminopolycarboxylic acids or hydroxamic acids) is beneficial in providing improved detergency whilst capable of being made from renewable materials (e.g. plant-based) and readily biodegradable.

Said further organic acid used in the detergent composition of the invention can be any organic acid. Particularly good results were achieved with organic acids being polyacids (i.e. acids having more than one carboxylic acid group), and more particularly with di- or tricarboxylic organic acids. The organic acids used in the invention have an average molecular mass of at most 500 Dalton, more preferably of at most 400 Dalton and most preferably of at most 300 Dalton, the molecular mass being based on the free acid equivalent. In any case, preferably the organic acid is not a polymer-based acid. The organic acid employed in accordance with the invention preferably comprises 3 to 25 carbon atoms, more preferably 4 to 15 carbon atoms.

In view of consumer acceptance and reducing environmental impact, the organic acids preferably are those which are also found naturally occurring, such as in plants. As such, organic acids of note are acetic acid, citric acid, aspartic acid, lactic acid, adipic acid, succinic acid, glutaric acid, malic acid, tartaric acid, maleic acid, fumaric acid, saccharic acids, their salts, or mixtures thereof. Of these, of particular interest are citric acid, aspartic acid, acetic acid, lactic acid, succinic acid, glutaric acid, adipic acid, gluconic acid, their salts, or mixtures thereof. Citric acid was found highly advantageous. Citric acid is naturally occurring, highly biodegradable as well as providing added builder activity and disintegration properties.

Advantageously the detergent composition of the invention comprises a free acid equivalent of organic acid of from 1 to 30 wt. %, more preferably of from 5 to 20 wt. % and even more preferably from 8.0 to 15 wt. %.

Inclusion of organic acids derived from natural sources can aid in raising the pMC level of the packaged machine dishwash detergent composition as a whole.

Preferred salt forms of the further organic acid are alkali metal salts and beneficially their sodium salts.

### Further Builders

Further builder materials may be selected from 1) calcium sequestrant materials, 2) precipitating materials, 3) calcium ion-exchange materials and 4) mixtures thereof. Examples of calcium ion-exchange builder materials include the various types of water-insoluble crystalline or amorphous aluminosilicates, of which zeolites are known representatives, e.g. zeolite A, zeolite B (also known as zeolite P), zeolite C, zeolite X, zeolite Y and also the zeolite P-type as described in EP-A-0,384,070. Zeolite and carbonate (carbonate (including bicarbonate and sesquicarbonate) are preferred further builders. The builder may be crystalline aluminosilicate, preferably an alkali metal aluminosilicate, more preferably a sodium aluminosilicate. This is typically present at a level of less than 15 wt. %. Aluminosilicates are materials having the general formula: 0.8-1.5 M₂O·Al₂O₃·0.8-6 SiO₂, where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alkali carbonate is appreciated in view of its double function as builder and buffer and is preferably present in the detergent composition. The preferred amount of alkali carbonate in the detergent composition is from 2 to 75 wt. %, more preferably from 10 to 50 wt. % and even more preferably from 20 to 40 wt. %. Such level of alkali carbonate provides good Ca²⁺ and Mg²⁺ ion scavenging for most types of water hardness levels, as well as other builder effects, such as providing good buffering capacity. The preferred alkali carbonates are sodium- and/or potassium carbonate of which sodium carbonate is particularly preferred. The alkali carbonate present in the detergent composition of the invention can be present as such or as part of a more complex ingredient (e.g. sodium carbonate in sodium percarbonate).

The detergent composition is advantageously phosphate-free, i.e., contains less than 1 wt. %, preferably at most 0.5 wt. % of phosphate and more preferably contains essentially no phosphate. The detergent composition is beneficially phosphonate-free i.e., contains less than 1 wt. % of phosphate, preferably at most 0.5 wt. %, more preferably at most 0.2 wt. % of phosphonate and more preferably contains essentially no phosphonate. Examples of phosphonates and phosphates are 1-hydroxyethane-1,1-diphosphonic acid (HEDP), diethylenetriamine-penta (methylenephosphonic acid) (DTPMP), ethylenediaminetetra-methylenephosphonate (EDTMP), tripolyphosphate and pyrophosphate.

### Bleach

The detergent composition of the invention preferably comprises from 0.1 to 25 wt. % of bleach. Inorganic and/or organic bleaches can be used. Bleach may be selected from peroxides, organic peracids, salts of organic peracids and combinations thereof. Advantageously the bleach is selected from peroxides (including peroxide salts such as sodium percarbonate), organic peracids, salts of organic peracids and combinations thereof. More preferably, the bleach is a peroxide. Most preferably, the bleach is a percarbonate. Further preferred, the bleach is a coated percarbonate. If present, preferred amounts of bleach are from 1.0 to 25 wt. %, more preferably at from 2.0 to 20 wt. %, even more preferably from 5 to 15 wt. %.

### Bleach Activators

The detergent of the invention preferably comprises one or more bleach activators such as peroxyacid bleach precursors. Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sul phonate (SBOBS) and the cationic peroxyacid precursor (SPCC) as described in U.S. Pat. No. 4,751,015. A beneficial amount of bleach activator is from 0.1 to 10 wt. %, more preferably from 0.5 to 5 wt. % and even more preferably from 1.0 to 4 wt. %.

### Bleach Catalyst

Bleach catalysts function by oxidizing typically via peroxide or a peracid to form a bleaching species. They require the presence of an oxidizable soil so that they can be reduced back to the starting bleach activator state. A preferred bleach catalyst is a manganese complex of formula (A):

[LₙMnₘXₚ]^{z}Yq,

wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula:

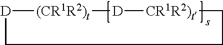

wherein R¹ and R² can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5. Such bleach catalysts are described in EP0458397A2.

The beneficial amount of bleach catalyst is from 0.0001 to 2.0 wt. %, more preferably from 0.001 to 1.5 wt. %, even more preferably from 0.01 to 1.0 wt. %.

### Enzymes

The detergent composition of the invention preferably comprises enzyme. Examples of enzymes suitable for use in the cleaning compositions of this invention include lipases, cellulases, peroxidases, proteases (proteolytic enzymes), amylases (amylolytic enzymes) and others. Well-known and preferred examples of these enzymes are proteases, amylases, cellulases, peroxidases, mannanases, pectate lyases and lipases and combinations thereof, of which proteolytic and amylolytic enzymes are the more preferred. Enzymes may be added in liquid, granular or in encapsulated form to the composition, but preferably are not encapsulated. If enzymes are present the composition preferably also contains enzyme stabilizers such as polyalcohols/borax, calcium, formate or protease inhibitors like 4-formylphenyl boronic acid.

Preferred levels of protease are from 0.1 to 10 mg, more preferably from 0.2 to 5 mg, most preferably 0.4 to about 4 mg active protease per gram of the detergent composition. Preferred levels of amylase are from 0.01 to 5, more preferably from 0.02 to 2, most preferably from 0.05 to about 1 mg active amylase per gram of the detergent composition.

### Dispersing Polymers

The detergent composition of the invention beneficially comprises dispersing polymer. Dispersing polymers can be chosen from the group of anti-spotting agents and/or anti-scaling agents. Examples of suitable anti-spotting polymeric agents include hydrophobically modified polycarboxylic acids such as Acusol™460 ND (ex Dow) and Alcosperse™747 by Nouryon, whereas also synthetic clays, and preferably those synthetic clays which have a high surface area can be useful to reduce spotting, in particular those formed where soil and dispersed remnants are present at places where the water collects on the floor when the water subsequently evaporates.

Suitable anti-scaling agents are water soluble dispersing polymers prepared from an allyloxybenzenesulfonic acid monomer, a methallyl sulfonic acid monomer, a copolymerizable non-ionicmonomer and a copolymerizable olefinically unsaturated carboxylic acid monomer as described in U.S. Pat. No. 5,547,612 or known as acrylic sulphonated polymers as described in EP851022. Polymers of this type include polyacrylate with methyl methacrylate, sodium methallyl sulphonate and sulphophenol methallyl ether such as Alcosperse™ M240 supplied (Nouryon). Also suitable is a terpolymer containing polyacrylate with 2-acrylamido-2 methylpropane sulphonic acid such as Acumer 3100 supplied by Dow. As an alternative, polymers and co-polymers of acrylic acid having a molecular weight between 500 and 20,000 can also be used, such as homo-polymeric polycarboxylic acid compounds with acrylic acid as the monomeric unit. The average weight of such homo-polymers in the acid form preferably ranges from 1,000 to 100,000 particularly from 3,000 to 10,000 e.g. Sokolan™ PA 25 from BASF or Acusol™425 from Dow. Also suitable are polycarboxylates co-polymers derived from monomers of acrylic acid and maleic acid, such as CP5 from BASF. The average molecular weight of these polymers in the acid form preferably ranges from 4,000 to 70,000. Modified polycarboxylates like Sokalan™ CP50 from BASF or Alcoguard™4160 from Nouryon may also be used. Mixture of anti-scaling agents may also be used. Particularly useful is a mixture of organic phosphonates and polymers of acrylic acid.

If present, the preferred amount of dispersing polymer is from 0.1 to 6 wt. %, more preferably from 0.2 to 4 wt. %, and even more preferably from 0.3 to 2 wt. %.

### Perfume and Colorants

The detergent composition preferably comprises one or more colorants, perfumes and more advantageously a mixture thereof. Colorants are beneficially present in an amount of from 0.0001 to 8 wt. %, more preferably from 0.001 to 4 wt. % and even more preferably from 0.001 to 1.5 wt. %.

Preferably, the composition comprises perfume. Preferably the composition comprises 0.1 to 10 wt %, more preferably 0.2 to 5 wt %, even more preferably 0.3 to 3 wt % and still even more preferably from 0.35 to 1 wt. % of perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co. In perfume mixtures preferably 15 to 25 wt. % are top notes. Top notes are defined by Poucher (Journal of the Society of Cosmetic Chemists 6 (2): 80 [1955]). Preferred top-notes are selected from citrus oils, linalool, linalyl acetate, lavender, dihydromyrcenol, rose oxide and cis-3-hexanol.

Preferably the perfume comprises a fragrance component selected from the group consisting of ethyl-2-methyl valerate (manzanate), limonene, dihyro myrcenol, dimethyl benzyl carbonate acetate, benzyl acetate, geraniol, methyl nonyl acetaldehyde, Rose Oxide, cyclacet (verdyl acetate), cyclamal, beta ionone, hexyl salicylate, tonalid, phenafleur, octahydrotetramethyl acetophenone (OTNE), the benzene, toluene, xylene (BTX) feedstock class such as 2-phenyl ethanol, phenoxanol and mixtures thereof, the cyclododecanone feedstock class, such as habolonolide, the phenolics feedstock class such as hexyl salicylate, the C5 blocks or oxygen containing heterocycle moiety feedstock class such as gamma decalactone, methyl dihydrojasmonate and mixtures thereof, the terpenes feedstock class such as dihydromycernol, linalool, terpinolene, camphor, citronellol and mixtures thereof, the alkyl alcohols feedstock class such as ethyl-2-methylbutyrate, the diacids feedstock class such as ethylene brassylate, and mixtures of these components.

Preferably the composition comprises linalool, citronellol, limonene or combinations thereof. Linalool is an especially preferred.

Preferably the composition comprises 0.01 to 10 wt %, more preferably 0.05 to 5 wt % and even more preferably 0.1 to 3 wt % of the aforementioned fragrance components.

We have found that performance benefits are seen with using certain fragrance components such as octahydro tetramethyl acetophenone (OTNE), when using surfactant of the invention. In particular, we have found that using surfactants of the invention in the composition means that more fragrance components are present in the headspace meaning that more fragrance is perceived by the consumer when opening the container containing the composition.

The type(s) and level of perfumes are preferably chosen such as not to completely mask the odor provided by the surfactant of the invention. Perfumes can be however beneficial added to provide desirable accompanying scents.

### Form of the Detergent Composition

The detergent composition of the invention may be in any suitable form, such as in the form of a liquid (e.g. gel) or powder. The detergent composition may be in a unit-dose or non-unit dose form. Examples of unit-dose forms are tablets and capsules and these are preferred forms of the machine dishwash detergent composition of the invention.

The detergent composition is preferably provided as a water-soluble or water-dispersible unit dose. Particularly preferred unit doses are in the form of pouches, which comprise at least one further non-shape stable ingredient, such as a liquid and/or powder; or in the form of tablets. For ease of use, the unit dose is sized and shaped as to fit in the detergent cup of a conventional domestic machine dishwasher. In a preferred embodiment, the unit-dose detergent composition has a unit weight of 5 to 50 grams, more preferably a unit weight of 10 to 30 grams, even more preferably a unit weight of 12 to 25 grams. Advantageous unit dose pouches preferably have more than one compartment. Advantageous unit dose tablets are those which have more than one visually distinct tablet region. Such regions can be formed by e.g. two distinct (colored) layers or a tablet having a main body and a distinct insert, such as forming a nested-egg. However oriented, one benefit of using multi-compartmental pouches/multi-region tablets is that it can be used to reduce/prevent undesired chemical reactions between two or more ingredients during storage by physical segregation.

Preferably the unit dose detergent composition is wrapped to improve hygiene and consumer safety. The wrapper advantageously is based on water-soluble film which preferably a polyvinylalcohol (PVA) based film. Such wrapping prevents direct contact of the detergent composition with the skin of the consumer when placing the unit dose in the detergent cup/holder of a e.g. machine dishwasher. A further benefit of course is that the consumer also does not need to remove a water-soluble wrapping before use. The detergent composition according to the invention can be packaged in any suitable container, such as in a bottle (e.g. in case of a liquid or gel), a box (e.g. in case of a free-flowing powder) or a box or bag (in case of a multi unit-dose pack). In all cases the headspace composition will be altered by the presence of the machine dishwash detergent composition of the invention. More importantly it will be altered by virtue of the presence of a surfactant of the invention and in a manner which is distinct from whether using similar surfactant derived from a fully petrochemical source.

Whatever type of unit-dose wrapping material is used, obviously the film-wrap is preferably at least partly gas-permeable.

It is preferred that the packaged machine dishwash composition is stored for at least 2 days, more preferably at least 5 days, even more preferably at least 1 week before first opening of the pack by the end-user. This allows the headspace to sufficiently acquire the distinct gas-profile afforded by the detergent composition of the invention.

Although any packaged detergent composition will comprise at least some headspace volume, preferred headspace volumes are from 1 to 50% of the total (closed) package volume, more preferably from 2 to 30%, even more preferably from 5 to 20% and still even more preferably from 6 to 10%.

The detergent compositions according to the invention can be made using known methods and equipment in the field of detergent composition manufacturing.

### Process of Manufacture

The packaged machine dishwash detergent composition according to the invention can be made in any suitable methods known in the art. A preferred process for the manufacture of a packaged machine dishwash detergent comprises the steps of:
a) providing, in any particular order, an open package, a surfactant according to the invention, and optionally further detergent ingredients; and
b) filling the open package with the surfactant and any further detergent ingredients, wherein the detergent composition as a whole can be added in the form of film-wrapped unit-doses; and
c) closing the package containing the machine dishwash detergent composition;
   wherein the surfactant is made by a process including the steps of:
1) providing a, preferably captured, C1-source, preferably CO₂ and/or CO; and
2) gas-fermenting the C1 carbon to provide a gas-fermentation product which preferably is a C2 product and more preferably is ethanol or ethylene; and
3) providing the surfactant in a method which incorporates the carbon of the gas-fermentation product in the final surfactant, which preferably included a step which converts ethanol and/or ethylene into ethylene oxide.

The preferred gas-fermentation methods applied at step 2 comprise anaerobic gas fermentation and/or aerobic methane fermentation and more preferably comprise anaerobic gas-fermentation of COx.

The gas-fermentation product provided at step 3, used as intermediate to make the final surfactant, preferably is ethanol, ethylene, acetic acid, butanol, butyric acid, methanol, formaldehyde or a combination thereof, but more preferably is ethanol and/or ethylene.

To ensure that the consumer before first opening of the pack is provided with a clear olfactory impression of the surfactant-source contained, the closed pack obtained at step 3 is preferably stored for at least 2 days, more preferably 7 days, even more preferably at least 14 days before first opening. The storage conditions are preferably standard conditions, but can be at local room temperature (e.g. between 18 and 25 degrees Celsius).

At step 3) of the process, of the 2 to 100 ethoxylate units preferably at least 10%, 20%, 30%, 40%, 50% 60%, 70%, 80%, 90% and still even more preferably all of the ethoxylate units are derived from pre-cursors which are obtained via gas-fermentation.

Unless stated otherwise or is apparent from the context of the description, preferred embodiments mentioned for one aspect of the invention applies mutated mutandis to the other aspects of the invention as well. The below examples are meant to be illustrative and not limiting.

### EXAMPLES

The following non-ionic surfactants are illustrated and are all alcohol ethoxylates as described herein. Non-ionic surfactants 1 and 5 are comparative while 2, 3, 4, 6, 7 and 8 are inventive.

| | Ethoxylate (7EO) | Alkyl (C12) |
|---|---|---|
| Comparative 1 | Petro | Petro |
| Example 1 | Petro | Carbon Capture |
| Example 2 | Carbon Capture | Petro |
| Example 3 | Carbon Capture | Carbon Capture |

| | Ethoxylate (7EO) | Alkyl (C18) |
|---|---|---|
| Comparative B | Petro | Petro |
| Example 4 | Petro | Carbon Capture |
| Example 5 | Carbon Capture | Petro |
| Example 6 | Carbon Capture | Carbon Capture |

All the surfactants here are suitable for storage as a solution or suspension 50-95% in water. It should be appreciated that the ratio of Carbon Capture to Petro derived carbon can vary within batches. In any case, in the context of these examples, ‘Carbon capture’ means that at least 10% of the carbon atoms in the appropriate part of the molecule are obtained from carbon capture means. By ‘Petro’ is meant that at least 90% of the carbons are obtained from petrochemical means. By Ethoxylate (XEO) is meant that the surfactant has a mole average number X ethoxylate groups. By Alkyl (CX) is means that the surfactant has a mole average of X atoms in the alkyl chain.

An illustrative base detergent composition in the form of a tablet is set out in Table 1.

TABLE 1
Machine dishwash detergent tablets (amounts
as expressed by wt. % actives).

| Ingredient | |
|---|---|
| Na carbonate | 35.0 |
| MGDA | 12.0 |
| Tri-Na citrate | 9.9 |
| Na Disilicate | 4.0 |
| Na Sulphate | 5.6 |
| ¹surfactant | 5.0 |
| Na percarbonate | 11.4 |
| TAED | 2.8 |
| Bleach catalyst | 0.01 |
| ²polymer | 2.8 |
| Water | To balance |

¹surfactants: a non-ionic according to any one of the Examples 1 to 6 or according to Comparative A or B.
²polymer: Sokalan PA25CL (Supplier: BASF)

For headspace measurements, the tablets are placed in an airtight bag and stored at room temperature for 2 weeks. Gas is then extracted from the headspace of the bag using a syringe and analysed.

The extracted headspace gas can be compared by smell or by gas chromatography-mass spectrometry (GS-MS) to identify the differences in the gas composition. A suitable GS-MS method is described by Ruben Garnica ‘Analysis of Consumer Products by Headspace Trap GC/MS using the Clarus SQ 8’ (PerkinElmer Inc). The headspace of the compositions according to Examples 1 to 3 can be compared to those made with Comparative A. The headspace of the compositions made with a surfactant according to Examples 4 to 6 can be compared to those made with Comparative B.

### Example 2

Sensorial testing was performed on non-ionic surfactants which were C12-alcohol ethoxylates with an average of 7EO. A C12-alcohol ethoxylate-7EO non-ionic surfactant according to the invention was obtained of which the EO-polymer moiety was derived from a process which involved gas fermentation to reduce gaseous captured CO₂ to ethanol, wherein the ethanol was further converted to ethylene and used to make the EO-polymer. The alkyl-chain was obtained from a bio-source. A C12-alcohol ethoxylate-7EO non-ionic not according to the invention was obtained, also with an alkyl chain derived from a bio-source, but where the EO-polymer chain was derived from a petrochemical source. The surfactants were used to make a detergent formulation before testing. The detergent formulations were either tested at 20 degrees Celsius or heated to 40 degrees Celsius. The formulations, which otherwise contained no added perfumes were tested by a human nose.

The surfactant according to the invention provided a ‘waxy/fatty’ odour whereas the petrochemically derived surfactant provided a ‘chemical’ odour. The odour perception was verified by two persons independently.

### Example 3

The headspace of the detergent formulations with either the surfactant of the invention or the surfactant with the petrochemically derived EO-polymer was further analysed by GC-MS. This further surprisingly revealed that the headspace of the detergent formulation containing the surfactant of the invention provided about twice the amounts of total volatile compounds.

### Example 4

| | L | M |
|---|---|---|
| Limonene | 100 | 86 |
| cis rose oxide | 100 | 88 |
| trans rose oxide | 100 | 89 |
| C10 aldehyde | 100 | 81 |
| verdox (i) | 100 | 85 |
| C11 aldehyde ulenic | 100 | 80 |
| verdox (ii) | 100 | 82 |
| Methyl dihydrojasmonate | 100 | 55 |
| OTNE | 100 | 81 |
| Musk Z4 | 100 | 76 |

Detergent compositions comprising fragrance components were prepared and assessed for headspace fragrance analysis.

The table shows the normalized results for the surfactant with the petrochemically derived EO-polymer (M) versus the equivalent comprising carbon captured raw materials for manufacturing the EO units which included the step of gas-fermentation in their synthesis (L). For the fragrance components listed, all were present in the headspace in greater concentrations for surfactant according to the invention than for the surfactant with the petrochemically derived EO-polymer.

1. A packaged machine dishwash detergent composition comprising a surfactant comprising a C8-22 alkyl chain and a mole average of from 2 to 100 ethoxylate units, wherein the surfactant is made by a manufacturing process including the step of using one or more surfactant-precursors obtained via gas-fermentation; and
wherein the surfactant has a pMC level of at least 5%; and
wherein the packaged machine dishwash detergent composition is obtainable by the process of claim 12.

2. The packaged machine dishwash detergent composition according to claim 1, wherein the gas-fermentation converts a gaseous C₁-substrate to a C₂ gas-fermentation product.

3. The packaged machine dishwash detergent composition according to claim 1, wherein the surfactant has at least a pMC level of at least 10%, as based on the total surfactant.

4. The packaged machine dishwash detergent composition according to claim 1, wherein the composition has at least a pMC level of at least 10%, as based on the composition as a whole.

5. The packaged machine dishwash detergent composition according to claim 1, wherein the alkyl chain is derived from a bio-based triglyceride.

6. The packaged machine dishwash detergent composition according to claim 1, wherein the surfactant is a non-ionic surfactant alcohol ethoxylate.

7. The packaged machine dishwash detergent composition according to claim 1, wherein at least part of the 2 to 100 ethoxylate units of the surfactant is manufactured from pre-cursors which are obtained via gas-fermentation.

8. The packaged machine dishwash detergent composition according to claim 1, wherein the composition is a unit dose.

9. The packaged machine dishwash detergent composition according to claim 1, wherein the composition comprises from 0.5 to 20 wt. % free acid equivalent of aminopolycarboxylate.

10. The packaged machine dishwash detergent composition according to claim 9, wherein the aminopolycarboxylate comprises GLDA (glutamic acid N,N-diacetic acid), MGDA (methylglycinediacetic acid), EDDS (ethylenediaminedisuccinic acid) or a mixture thereof.

11. The packaged machine dishwash detergent composition according to claim 1, wherein the composition comprises from 1 to 30 wt. % free acid equivalent of organic acid, different from aminopolycarboxylate, and wherein said organic acid comprises di- or tri-carboxylic acids, or mixtures thereof having a free acid equivalent average molecular mass of at most 400.

12. A process for the manufacture of a packaged machine dishwash detergent composition, comprising the steps of:
a1) providing a surfactant which has a pMC level of at least 5% and which comprises a C8-22 alkyl chain and a mole average of from 2 to 100 ethoxylate units, which is made by a process including the steps of:
1. providing a C1 source comprising CO₂, CO or a combination thereof;
2. gas-fermenting the gaseous C1 to provide a gas-fermentation product which is ethanol or ethylene; and
3. providing the surfactant in a method which incorporates the carbon of the C₁ fermentation product in the final surfactant including a step which converts ethanol, ethylene or a combination thereof into ethylene oxide;
thereby providing a surfactant according to a1); and
a2) providing, in any particular order, an open package, the surfactant provided by a1), and optionally further detergent ingredients; and
b) filling the open package with the surfactant and any further detergent ingredients, wherein the detergent composition as a whole can be added in the form of film-wrapped unit-doses; and
closing the package containing the machine dishwash detergent composition;
c) providing the surfactant in a method which incorporates the carbon of the C₁ to provide a packaged machine dishwash composition.

13. The process according to claim 12, wherein the gas-fermentation at step 2) comprises anaerobic gas-fermentation, aerobic methane fermentation or a combination thereof.

14. The process according to claim 12, which further includes the step of storing the closed package obtained at step c) at room temperature for at least 2 days before first opening.

15. A method of providing a scent marker in a machine dishwash detergent to indicate the use of bio-fermentation in the manufacture the surfactant, which includes the manufacture of any used surfactant precursors, the method comprising providing the packaged machine dishwash detergent composition according to claim 1.
